(19) United States
(12) Patent Application Publication
(10) Pub. No.: US 2026/0222915 A1
(43) Pub. Date: Jul. 30, 2026

(54) UNIFIED RAN - OPTO SYSTEM

(71) Applicant: Mariana Goldhamer, Ramat Gan (IL)

(72) Inventor: Mariana Goldhamer, Ramat Gan (IL)

(21) Appl. No.: 19/302,774

(22) Filed: Aug. 18, 2025

Related U.S. Application Data
(60) Provisional application No. 63/684,396, filed on Aug. 18, 2024.

(51) Int. Cl. H04W 28/082; H04B 10/27; H04B 10/29; H04W 28/02; H04W 76/15

(52) U.S. Cl. CPC H04W 28/082; H04B 10/27; H04B 10/29; H04W 28/0226; H04W 76/15

(57) ABSTRACT

A unified RAN-OPTO system comprises a base station partitioned into Central Unit (CU) and evolved Distributed Units (eDU) including multiple DUs, each one including at least a MAC (Medium Access Control) and a part of the PHY Layer and Remote Radio Units (RRU), connected through an Optical (OPTO) Network to eDU and through radio to User Equipments (UE). A controller of the unified RAN-OPTO system operation selects at least one DU for conveying user data and control information between RRUs and the selected DU and establishes a communication path between the CU and the selected DU, and an optical communication path through the OPTO configurable nodes, between the selected DU and specific RRUs. The UEs connect to the specific RRUs, and to the CU through the RAN and OPTO networks, and convey user data and/or control information to CU through the selected DU.

### CROSS-REFERENCE TO RELATED APPLICATIONS

This application claims priority from the U.S. provisional patent application No. 63/684,396 entitled “A UNIFIED RAN-OPTO ARCHITECTURE”, filled on Aug. 18, 2024, which is incorporated here by reference in its entirety.

### PRIOR ART

No prior art related to unified RAN-OPTO architecture, defined by the existence of an Area RAN-OPTO System Controller, is known to the inventor.

### FIELD OF THE INVENTION

This invention relates generally to digital communication systems and in particular to unified cellular and photonic systems. In addition, the real-time development of a digital twin for enabling better mobility within the unified RAN-OPTO system is addressed.

The list of abbreviations used in this document is provided at the end of this specification.

### BACKGROUND OF THE INVENTION

Optical networks are used currently in cellular deployments as transport medium for backhaul and/or for fronthaul connectivity. The optical and radio systems do not interact between them, leading to higher costs and energy consumption.

Providing the required QoS (Quality of Service) in mobility scenario was never a criteria for planning the mobile trajectory of mobile users between the start and destination points. Digital cellular deployment twins for enabling this approach were not defined.

### SUMMARY OF THE INVENTION

The disclosure may be summarized by referring to the appended claims.

The invention provides a solution for integrating the Radio Access Network (RAN) and the Optical transport system, by unifying the RAN and OPTO (Optical) systems and creating a unique control framework for both systems.

An important advantage of this invention is that the eCPRI (enhanced Common Public Radio Interface), used as a logical interface between the RAN system and the OPTO system, is mapped to one or more optical wavelengths and transported, switched and beam-formed within the optical network, such that no conversion to Ethernet is needed within the OPTO network.

The existing proposals for cellular digital twins are based on ray-tracing technologies trying to describe in a 3D urban environment the possible propagation path(s) of a radio beam, while accounting for the material characteristics of the buildings as described in ITU documents. However, the received radio signal is affected by many other factors which are not accounted for in this approach.

The simulated radio signal at receiver is obviously imprecise and frequent calibrations are needed for the theoretical Digital Twins, making their use not practical in the real-world deployments.

The main use of the Digital Twins is the predictive estimation of achievable data rates and other QoS parameters in different UE (User Equipment) locations.

A scope of this invention is to define Digital Twins of the unified RAN-OPTO deployment for allowing a prediction of user QoS performance while moving within the served area.

### BRIEF DESCRIPTION OF THE DRAWINGS

For a more complete understanding of the present invention, reference is now made to the following detailed description to be used in conjunction with the accompanying drawings.

The drawings do not represent an exhaustive representation of the possible embodiments of the invention and the invention is not limited to the arrangements presented in the drawings.

The drawings are:

FIG. 1— Represents a high-level RAN-OPTO unified architecture according to this invention.

FIG. 2A— Represents the main RAN part of the RAN-OPTO unified architecture.

FIG. 2B— Represents the OPTO part and a secondary RAN part of the RAN-OPTO unified architecture.

FIG. 3A— Represents a RAN-OPTO frame, wherein an OPTO header indicates whether the message body is OPTO-Native.

FIG. 3B— Represents a RAN-OPTO frame, wherein an OPTO header indicates that the optical wavelength is modulated with an RF signal.

FIG. 4— Represents a deployment example.

FIG. 5— Represents the block diagram of an Area Evolved Distributed Unit (eDU).

FIG. 6— Represents a Block Diagram of a computing platform.

FIG. 7— Represents a Block Diagram of an Optical Signal Processing Block.

FIG. 8— Represents the block diagram of a UE.

### DETAILED DESCRIPTION

In the following description, for the purposes of explanation, numerous specific details are set forth for providing a better understanding of the present invention by way of examples. It should be apparent, however, that the present invention may be practiced without these specific details.

The following description uses terminology familiar to those skilled in the art of wireless cellular networks and skilled in NR (New Radio)/5G technology. However, this fact should not be considered as restricting the applicability of the invention to these technologies, and the present invention also encompasses other similar technologies as well as evolving cellular technologies.

It is understood, for all the embodiments, that UE has previously executed the procedures for connection to the cellular network or, in sidelink communication, to another UE and is allowed at least to receive information over the air from the radio network or from the other UE. Fixed entities using sidelink communication are considered infrastructure entities.

### High Level System Architecture

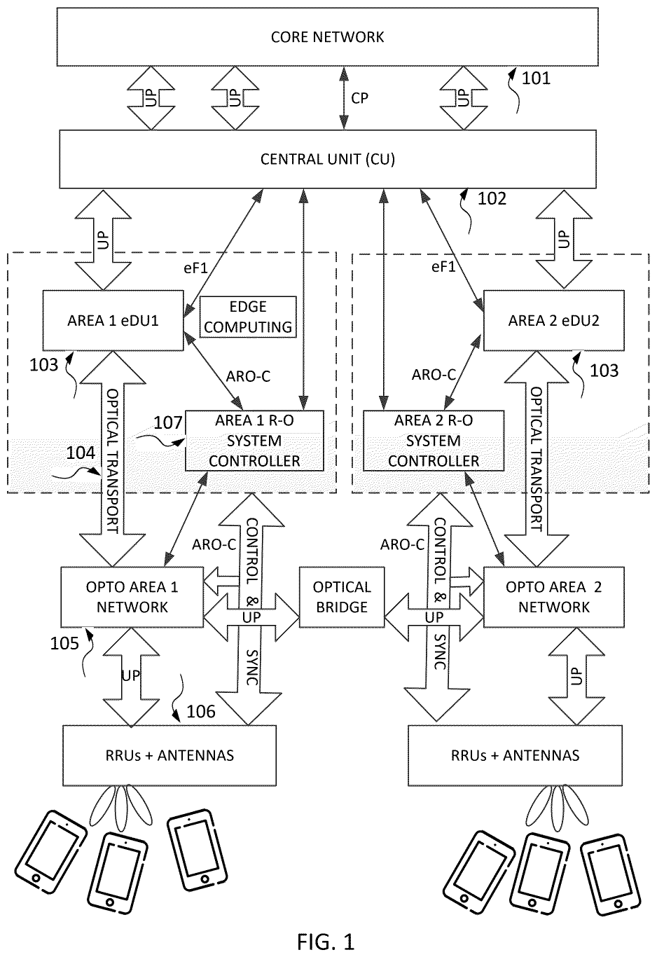

The high level RAN-OPTO system architecture is presented in FIG. 1. The cellular system architecture includes the Core Network—101 and the RAN (Radio Access Network), composed of the Central Unit (CU)—102 of the base station to which the eDU (Enhanced DU)-103 is connected, the eDU including Distributed Units (DU) serving the given Area. The eDU can be implemented on an Edge Computing platform or on a Cloud partition.

Scheduling of traffic within the area served by a DU is executed by its MAC (Media Access Control) entity.

The PHY (Physical) layer functions of each DU are split following one of the industry standards (Option 7.1, Option 7.2 (O-RAN Alliance), Option 8, etc.). The DUs are connected through Optical Transport—104 and an Area OPTO (Optical) Network-105 to one or more Remote Radio Units (RRU)—106, each including at least a power amplifier and one or more radio antennas (TRPs).

In this document all Radio Units are considered RRUs.

It should be noted that there are no amplifiers in TRPs, a TRP being defined as a set of geographically co-located antennas.

In addition, in a multi-TRP operation within a serving cell, a UE can be scheduled to receive downlink signals simultaneously from one or more TRPs of the serving cell.

The system formed by the eDU, the Area OPTO Network and the RRUs is controlled by an Area RAN-OPTO System Controller (Area R-O Controller)—107.

In prior art, the radio cell, identified by a Physical Cell ID, is an area served by a MAC entity through the connected PHY, the Radio Unit and the attached antennas (TRPs).

In an embodiment of this invention, the Area, formed by the smaller cells covered by the totality of DUs in eDU, is identified by an Area Identifier broadcasted by each DU within the eDU, in addition to or part of the Physical Cell ID.

In an embodiment of this invention, the UE mobility within the Area R-O System is executed within the eDU and/or within the corresponding Area OPTO Network, under the control of the Area R-O System Controller, which enables the redirection of the user plane data from the serving DU belonging to the eDU to the target DU belonging to the same eDU.

In an embodiment of this invention, the eDU provides radio connectivity to the served UEs through an optical fronthaul, using at least one optical wavelength up to one or more RRUs, which are connected to TRPs consisting of Radio Antennas (RA).

When the handover takes place between two different eDUs or between an eDU and the legacy DU, the CU or a Central Controller will be involved in such a HandOver (HO).

### RAN System Architecture

The 5G disaggregated RAN system (prior art) includes a Central Unit (CU) and Distributed Units, connected to antennas (TRPs) through RRUs. The DU includes the MAC sublayer, which is basically a radio cell controller, and the upper PHY Layer. Different split options within the PHY were defined, split option 7.2 allowing the allocation of some of DU PHY functions to be executed by an RRU.

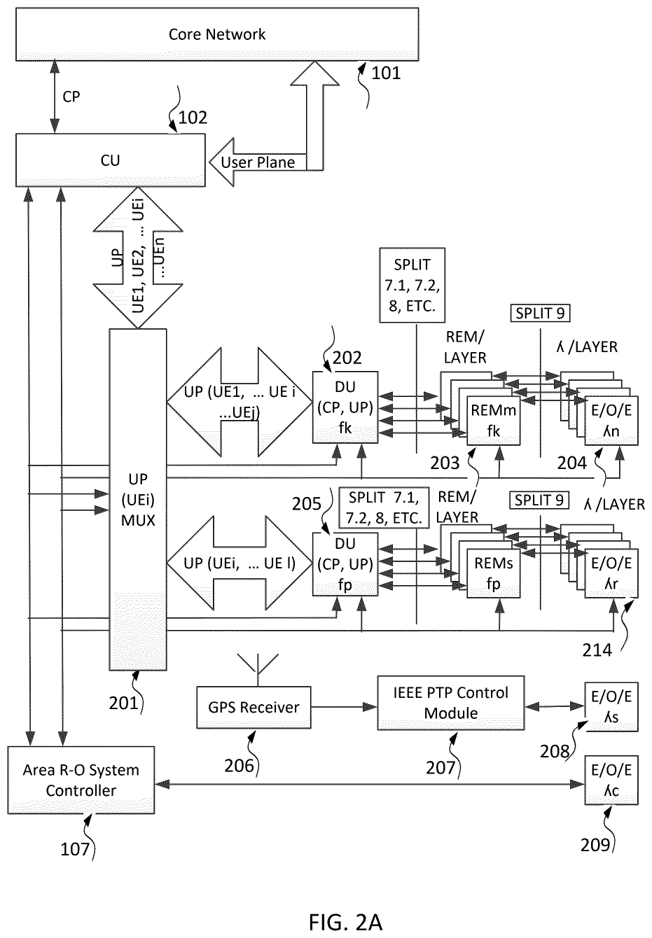

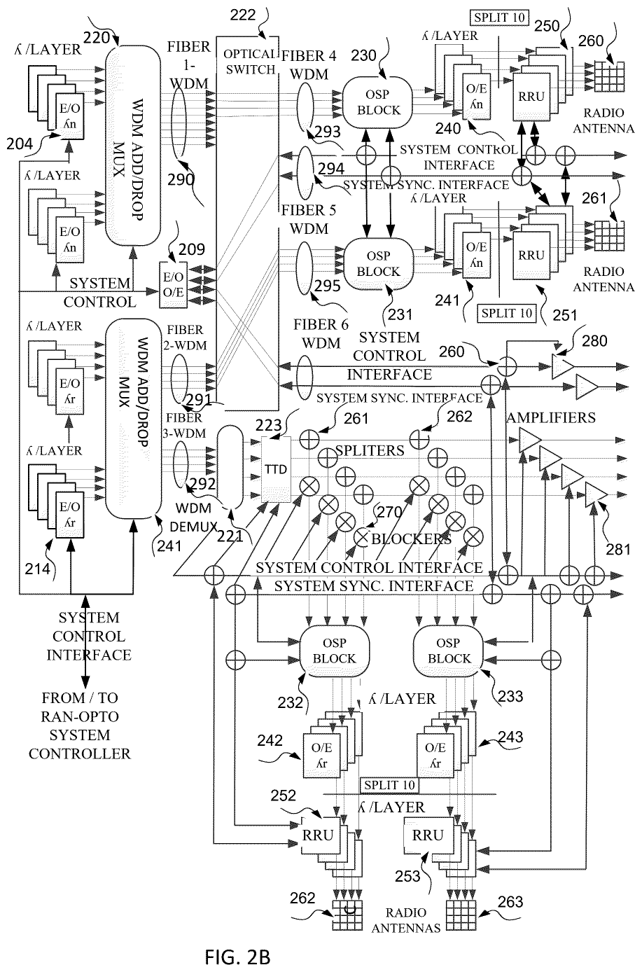

In FIG. 2A are given details of eDU and its connections.

eDU provides RAN services to the UEs in its coverage area and includes:

A. A multiplexer/demultiplexer—201 of UP (User Plane) data between the CU—102 and the serving DUs.

In an embodiment of this invention a UE can be served by several DUs, implying that either the data stream to be sent or received from a UE is split between the serving DUs or that a data stream or a part of it is transmitted to several DUs in parallel.

B. Distributed Units—202; each DU can be connected, for each one of the layers, to a RE-Modulator (REM)—203, used for output data compression, to be explained in continuation.

C. An Area R-O System Controller

In an embodiment of this invention, the Area R-O System Controller is connected to each DU within the eDU and is connected also through one or more dedicated E/O converters and one or more wavelengths to the controllable entities of the Area OPTO Network.

D. Electrical to Optical Converters—204, for example tunable Lasers managed by the Area R-O System Controller, which will allocate different wavelengths λn for DU-202 use per REM per layer and Ar for DU-205 use per REM per layer, such that each E/O Converter will generate an optical signal having a specific wavelength, modulated by the electrical signal received from the connected DU.

In the receive direction will be executed the reverse Optical to Electrical conversion.

In an embodiment of this invention, redirecting the UE traffic under the control of the Area R-O System Controller from the current serving DU to the target serving DU, intended for UE mobility support, DU load balancing, UE dual connectivity, make use of the UP (User Plane) eDU Multiplexer on the Edge Computing platform.

In this way, it is possible to provide faster and more reliable mobility support.

E. In an embodiment of this invention, the eDU includes a GPS receiver—206 connected to a PTP (Precision Time Protocol) Unit—207, which uses the IEEE 1588 protocol for measuring the delays between specific entities of the OPTO network and the eDU, allowing the synchronization of the OPTO Network, in each area.

The messages of IEEE 1588 standard and of the R-O System Controller are E/O converted, by the tunable lasers—208, to wavelengths allocated by the R-O System Controller and transmitted over Optical Fibers while using an Ethernet or IP with UDP for transport over Fiber. In the reverse direction O/E conversion is done.

In an embodiment of this invention, the component DUs of an eDU are additionally connected to the control plane of the CU.

### Electrical To Optical Conversion For Fronthaul

Fronthaul is defined as a communication link between a DU node and a remote RRU node connected to at least one antenna (TRP).

In this invention the electrical signals representing digital messages produced by the PHY layer of an infrastructure node, for example a base station or an RSU (Road Side Unit) or a Sidelink HUB, and which are transmitted after a certain processing to be explained below, are used for modulating a light transmitter, for example a tunable laser.

The lasers are connected to WDM (Wavelength Division Multiplexing) optical fibers, wherein each laser is transmitting a given optical wavelength (color) modulated by an electrical signal.

The electrical signal could represent messages defined as part of communication protocols used for the intra-PHY 3GPP defined split option 7.1, O-RAN Alliance defined split option 7.2 wherein the pertinent digital information is transmitted over Ethernet, messages defined as PHY-RRU split option 8 which may be digitally transmitted while using the eCPRI (enhanced Common Public Radio Interface) protocol, transmission of re-modulated (REM) split 8 baseband information as defined in this invention.

In addition to the information listed above, other information may be transmitted over the optical fronthaul.

In cases when digital pre-coding has been executed by the PHY layer of the DU, each pre-coded layer will be transmitted while using a different wavelength.

### OPTO System Architecture

An OPTO system, shortly described in FIG. 2B mainly for downlink, includes entities as: Tunable Lasers-204, converting the received electrical signals into light of a controlled wavelength, Add and Drop Multiplexers—220, 241, Optical Switches—222, optical attenuators, De-multiplexers—221, True Time Delay 223, Optical Splitters—260, 261, 262, Optical Blockers—270, Optical Amplifiers—281, Optical Signal Processing (OSP) Block —230, 231, Optical-to-Electric Converters—240, 241, 242, 243, converting the received optical signal into an electrical form suitable for reconstructing of the original signal or bit stream, and of course Optical Fibers—290 to 295 for the transport of modulated light.

In FIG. 2B it can be observed that several optical cables are connected to the optical switch and the output cables contain selected WDM optical In addition, it can be observed that the system control interface, connected to the RAN-OPTO System Controller, is connected to the E/O converters, the WDM ADD/DROP MULTIPLEXER, the OPTICAL SWITCH, the OSP Blocks, the True Time Delay (TTD) unit, to SPLITTERS and BLOCKERS, to O/E converters and to RRUs.

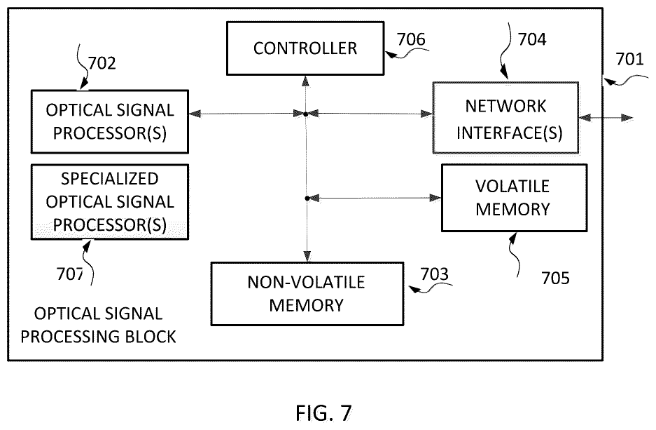

### OSP Block—FIG. 7

In an embodiment of this invention, the OSP Block replaces at least one of the components of the OPTO system from the list of: multiplexer, WDM multiplexer, demultiplexer, WDM demultiplexer, optical switch, optical blocker, optical splitter, optical filtering, optical amplification, optical attenuators, True Time Delay function, optical modulation, optical demodulation and optical beamforming.

While prior art (O-RAN split option 7.2) places functions as iFFT in downlink or FFT in up-link, digital beamforming, and eventually precoding within the RRU, in an embodiment of this invention these functions are allocated to the Optical Signal Processing Block, which will execute them while using only a very small percentage of the electrical power consumption required by the conventional DSP processing.

The OSP Block—701 (FIG. 7) includes at least one Optical Signal Processor—702, Optical RAM (Random Access Memory)—705, Non-volatile memory—703 and an Optical Communication Interface—704.

The Optical Communication Interface will execute the E-O and O-E conversions. OSP Block may include specialized optical computation elements—707, such as switches, optical splitters, blockers, amplifiers and attenuators.

In an embodiment of this invention, the OSP Block includes at least one of: specialized FFT or specialized iFFT optical computation elements—707.

In an embodiment of this invention, when coding and/or modulation is applied to the eCPRI messages, the OSP Block can execute the de-modulation and/or the de-coding.

### OSP Block With Split Option 7.2

The current O-RAN Alliance specifications (O-RAN.WG4.CUS.0-R003-V14.00), Split option 7-2, include for the Category A Radio the following RU (Radio Unit) functions for the PDSCH processing: Beamforming, iFFT and CP(Cyclic Prefix) addition, D/A (Digital to Analog) conversion and Analog Beamforming, while for Category B Radio The RU includes in addition the Precoding.

The Optical Signal Processing, at this time, is in its initial phase and its actual performance may not be sufficient for executing part of RU functions in Split 7-2.

In this invention the OSP Block and the following RRU (in downlink) can be configured by the Area R-O System Controller for using on the Optical side only the functions which are executed with the required performance, and, if this is not possible, to apply the O/E conversion for transferring the remaining jobs to RRU.

In an embodiment, each function in the OSP Block can be skipped based on the Area R-O System Controller decision.

OSP Block with Split Option 8—Analog Version

The Split option 8 can be used in digital form, as eCPRI transmitted iFFT outputs, or in analog form, after the D/A conversion of the iFFT outputs.

For small area deployments may make sense the use of the analog output (baseband signal), after its conversion to RF (not shown in FIG. 2A) by a Radio Unit included within the eDU, which will modulate the RF with this analog output and will filter the resulting signal.

There are two processing modes:
A. The resulting RF signal can be used to modulate an optical wavelength (E/O conversion) and can be transported through the optical system, converted by O/E converters to RF and provided to the target RRU for amplification.
B. Another possibility is to pass the optical wavelength through an analog optical beamformer before its delivery to O/E converters.

It should be noted that the analog optical beamformers can work with optical baseband signals or with optical RF signals.

In an embodiment of this invention all the optical system configurations for the use of analog RF signals are provided by the Area R-O System Controller.

In an embodiment of this invention an OSP Block can execute the optical beamforming of the received data stream through the fronthaul, instead of the PHY digital beamforming or as an addition to it.

The OSP Block can include iFFT processing and controllable amplifiers for generating an optical analog waveform, which can be converted to an electrical signal and converted by an RRU for obtaining a modulated RF signal to be applied to the suitable antenna port.

### Area R-O System Controller

In this invention each node within the OPTO network is addressable and controllable by the Area R-O System Controller.

Each controllable node provides reports on the current status and/or on message routing towards the final target of the message, to the Area R-O System Controller and it is configured or re-configured by the Area R-O System Controller through appropriate messages.

Examples of OPTO system configurations relevant to optical network entities are:

For a tunable laser, the wavelength to generate and modulate in E/O conversion.

For a wavelength selective Optical Add-Drop Multiplexer (OADM), the configuration of which specific wavelengths on input ports to add for transmission (MUX) on a single-mode Fiber and which wavelengths to direct (DE-MUX) to the output ports.

For a Wavelength Selective Switch (WSS), which is essential in a reconfigurable Agile Optical Network (AOC), the dynamic configurations refer to routing, blocking and attenuating of all DWDM wavelengths within WSS.

For an Optical Beamformer, phase control and/or the connection configuration of True Time Delay units.

For a variable optical power splitter, the split ratio between two or more ports.

For an optical reconfigurable power amplifier or attenuator, the amplification factor respectively the attenuation factor.

For an optical blocker, the blocker configuration:forward or block the optical signal.

More examples of configurations provided by the Area R-O System Controller can be found within the text of this invention.

### Split 8

In 5G architecture extension developed by O-RAN Alliance, is mentioned the RU (Radio Unit) which can be connected to the DU by split 7.2 or by split 8. The digital interfaces involved in these splits are transported over Ethernet and nothing is preventing their transport over the Optical Fibers.

eCPRI transmission on Split 8 involves a very high amount of data but has the advantage that all the PHY processing is executed within the DU, i.e. on a computing platform.

Another important advantage is that the eCPRI digital iFFT output can be easily mapped to one or more wavelengths and transported as wavelength in the optical network, such that no conversion to Ethernet will be needed within the OPTO network.

For reducing the data rate in the OPTO network, in an embodiment of this invention the eCPRI data is coded and QAM modulated. OPTO channel de-coding will be used for error detection and correction. An example of the data rate reduction is shown in Table 1.

The parameters used in computations are given within the Table 1. The results, computed for un-modulated and modulated iFFT digital outputs depend on the number of pre-coded layers.

TABLE 1
Performance of modulated eCPRI transmission over OPTO system

| DU | For separate CPRI I and Q streams | | | | | | | | | | | |
|---|---|---|---|---|---|---|---|---|---|---|---|---|
| Subcarrier | 30 | 30 | 30 | 30 | 30 | 30 | 30 | 30 | 30 | 30 | 30 | 30 |
| spacing (kHz) | | | | | | | | | | | | |
| FFT size | 4098 | 4098 | 4098 | 4098 | 4098 | 4098 | 4098 | 4098 | 4098 | 4098 | 4098 | 4098 |
| Sampling rate | 123 | 123 | 123 | 123 | 123 | 123 | 123 | 123 | 123 | 123 | 123 | 123 |
| (MS/s) | | | | | | | | | | | | |
| Pre-coded layers | 8 | 8 | 8 | 16 | 16 | 16 | 32 | 32 | 32 | 64 | 64 | 64 |
| CPRI bits for | 15 | 15 | 15 | 15 | 15 | 15 | 15 | 15 | 15 | 15 | 15 | 15 |
| I or Q/CPRIsample | | | | | | | | | | | | |
| 20% Overhead | 1.2 | 1.2 | 1.2 | 1.2 | 1.2 | 1.2 | 1.2 | 1.2 | 1.2 | 1.2 | 1.2 | 1.2 |
| (FEC, Headers, | | | | | | | | | | | | |
| CRC), DU or | | | | | | | | | | | | |
| OPTO | | | | | | | | | | | | |
| Total DU data rate | 17.7 | 17.71 | 17.7 | 35.4 | 35.4 | 35.4 | 70.8 | 70.8 | 70.8 | 142 | 141.7 | 141.7 |
| (Gb/s) per I or per | | | | | | | | | | | | |
| Q − CPRI | | | | | | | | | | | | |
| CPRI Number of | 2 | 2 | 2 | 3 | 3 | 3 | 5 | 5 | 5 | 10 | 10 | 10 |
| Lasers needed for | | | | | | | | | | | | |
| I + Q only | | | | | | | | | | | | |
| | For Modulated CPRI over OPTO | | | | | | | | | | | |
| (QAM) | 16 | 64 | 256 | 16 | 64 | 256 | 16 | 64 | 256 | 16 | 64 | 256 |
| Bits for I or Q | 2 | 3 | 4 | 2 | 3 | 4 | 2 | 3 | 4 | 2 | 3 | 4 |
| OPTO-M | | | | | | | | | | | | |
| Total bits per | 4 | 6 | 8 | 4 | 6 | 8 | 4 | 6 | 8 | 4 | 6 | 8 |
| symbol OPTO-M, I | | | | | | | | | | | | |
| Signal OPTO-M, | 8.86 | 5.904 | 4.43 | 17.7 | 11.8 | 8.86 | 35.4 | 23.6 | 17.7 | 70.8 | 47.23 | 35.42 |
| symbol BW (GS/s) | | | | | | | | | | | | |
| Per WDM laser | 30 | 30 | 30 | 30 | 30 | 30 | 30 | 30 | 30 | 30 | 30 | 30 |
| (GS/s) | | | | | | | | | | | | |
| Number of WDM | 1 | 1 | 1 | 1 | 1 | 1 | 2 | 1 | 1 | 3 | 2 | 1 |
| lasers needed for | | | | | | | | | | | | |
| I + Q only | | | | | | | | | | | | |

Table 1 shows that the modulation of the digital iFFT outputs can reduce by 2 to 5 times the number of lasers (and wavelengths) needed, which is an essential advantage in a WDM optical network.

In an embodiment of this invention, the RAN-OPTO controller will decide the modulation and the coding rate to be used for the transmission of the digital iFFT outputs.

We name REM (Re-Modulator) the functional entity executing the coding and modulation of eCPRI Split 8 data or any other data format, like Split 7.2 data, to be transmitted over the OPTO Network.

In an embodiment of this invention the REM function can work in a transparent mode (i.e. be skipped), by not executing any coding or modulation. In an embodiment of this invention, the configuration of the REM working mode is done by the Area R-O System Controller.

### Splits 9 And 10

In an embodiment of this invention the wavelength assignment to the downlink tunable lasers 204 (FIG. 2A, FIG. 2B) used in the selected Split Option is controlled by the Area R-O System Controller.

In this invention is defined the RRU and the Split 10, connecting the Optical network to/from the RRU.

In fact, the 5G PHY Layer supports max. two codewords, a codeword being defined as an information block with an appended CRC (Cyclic Redundancy Check) for error detection at receiver. The channel coding creates segments and adds parity bits and CRC to each segment. Each coded segment can be split into data layers for MIMO (Multiple Input and Multiple Output) support, for max. two codewords per carrier.

In the process of beamforming or MIMO special multiplexing, the data layers and the DMRS (De-Modulation Reference Signal) are processed by a pre-coding matrix, creating data streams to be mapped to antenna ports, wherein an antenna port is associated with a propagation spatial channel.

As result, at the output of precoding matrix are obtained a high number of layers/antenna port data streams, their number depending of the actual antenna used.

In an embodiment of this invention, the split between the RAN and the Opto Network is named Split 9 of the converged RAN-OPTO Network and the split between the OPTO Network and the RRU (Remote Radio Unit) is named Split 10.

In an embodiment of this invention, in Split 9 and consequently in Split 10 each data stream to/from a certain layer/antenna port should be transported on its specific wavelength.

The optical wavelength is transmitted through WDM or DWDM (Dense Wavelength Division Multiplexing) Optical Fibers (OFB) and can be processed within optical nodes such to allow its splitting between Optical Fibers or its switching from one OFB to another OFB, such to gradually expand the number of radio nodes (RRUs) attached to it and by this to expand its serving area.

In an embodiment of this invention, an Optical Fiber and Wavelength Identifier (FWID) is transmitted in addition or instead of a Physical Cell ID.

A MAC entity within the eDU will schedule the connected PHY layer data transmissions intended for a given one or more RRUs and/or RAs to which a specific wavelength of a given Fiber is connected.

### UE Mobility

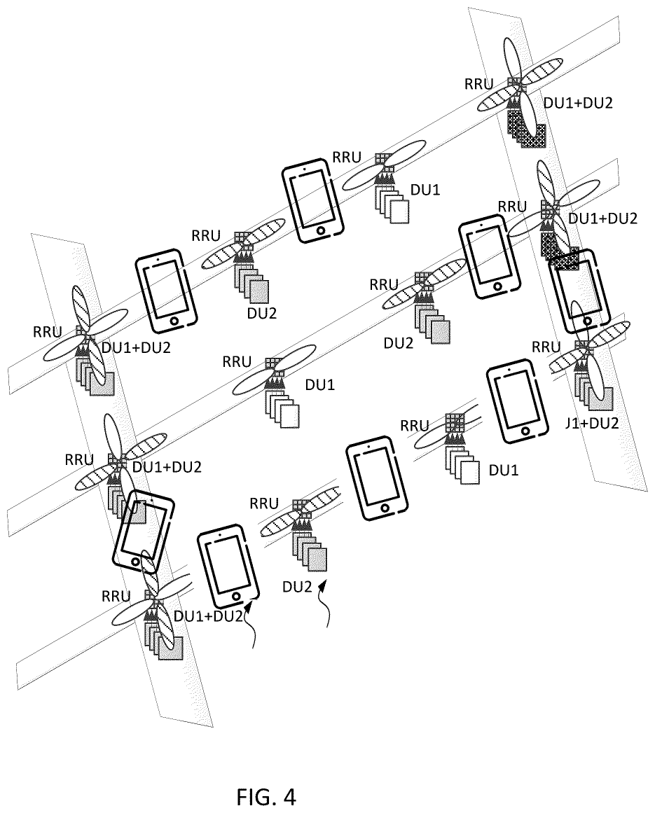

In an embodiment of this invention, the UE mobility from an RRU connected to a first DU to another RRU connected to a second DU, while both RRUs are connected through identical wavelengths, can be executed by optical switching. For example, in a deployment scenario like in FIG. 4, consider a group of vehicles moving in the same direction on the road and entering from the coverage area of a first DU1 and its connected first RRUs to the coverage area of a second DU2 and its connected second RRU.

In this case, the inter-DU handover at eDU level can be avoided and just optically connect, under the Area R-O System Controller commands, at least one of second RRUs to the first DU1. This can be simply done by using optical switches or opto light splitters.

The result is a CELL-FREE OPERATION for UEs moving with the same speed.

Note that in the above example there is no need for UE traffic redirection, and the time restrictions related to the existing handover procedures do not apply.

As an extension, several RRUs can be deployed on a street with pedestrian UEs and mobile cars. A first DU can send through multiple RRUs the same PDSCH (Physical Downlink Shared Channel) to all scheduled pedestrian UEs while using a first DU for a first set of PHY time-frequency resources. A second DU can use for each group of mobile users one or more second set of time-frequency-polarization-space resources transmitted by selected RRUs close to mobile group location, creating a CELL-FREE mobile MIMO operation.

The remaining RRU can be further split into RRUs needed for coverage and RRUs which can have their radio amplifiers switched off, for reducing the energy consumption.

The existing standards allow to attach several RRUs, each identified by an Ethernet address, to a PHY layer but do not provide means for identifying an RRU based on its OPTO Network Identifier and/or by its position.

### OPTO Native Transmissions

For avoiding frequent E/O and O/E conversions, when using the Ethernet ID of a node, in this invention there is an association between an Ethernet ID and a OPTO ID. An OPTO header attached to a message transmitted over an OPTO network will include the source and destination OPTO-IDs.

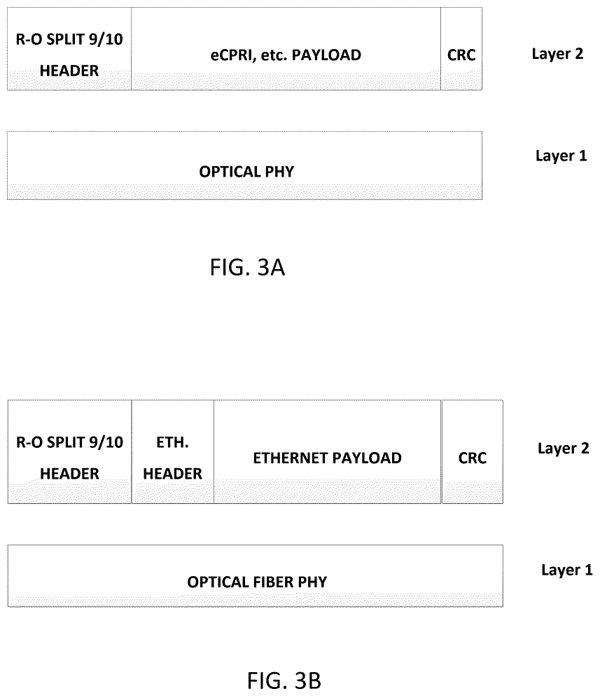

In an embodiment of this invention an OPTO header (FIG. 3A, FIG. 3B) will indicate whether the message body is OPTO-Native (FIG. 3A), i.e. each one or multiple bits of the message itself (for example eCPRI) is transmitted by using optical modulation, or that the optical wavelength is modulated with an RF signal produced by another protocol, (FIG. 3B) for example Ethernet transporting the eCPRI messages.

In an embodiment of this invention the Area R-O System Controller will keep tables correlating between the OPTO ID of a node and its connection to a specific OPTO Fiber and, in case of WDM, also a specific wavelength.

The AREA RAN-OPTO System Controller will be able to change the specific wavelength to which an OPTO node is connected, through commands to the optical nodes supporting the Wavelength Conversion feature.

UE mobility from a RRU to another RRU connected to different Wavelengths requires either:
A. UE handover within the eDU from the serving DU to the other DU serving the other RRU while keeping the wavelengths unchanged (for not altering the phase of the radio modulated signals).
B. Changing the OPTO network configuration for attaching the other RRU to the wavelength connected to the initial Radio Node and sharing the same radio frame between two DUs.

While in the existing networks specific wavelengths are semi-permanently allocated to specific RRUs, in an embodiment of this invention a group of vehicles moving with similar speeds on same path will be preferably connected with a same specific wavelength. When the group of vehicles exits from the coverage area of a first RRU connected to a first DU and enters into the coverage area of a second RRU, the specific wavelength is either connected to the second RRU while remaining connected to the first DU or is connected to both RRUs.

A second wavelength can be allocated to pedestrian users and it will not change the connection to the initial DU.

A third DU may handle the traffic of vehicles with a different moving speed.

Each DU will be assigned a different radio channel, such that the RRU will aggregate the transmission on the three carriers.

Carrier Aggregation will preferably not be used, to eliminate the need for using a given carrier component for control information transmission.

Beam-forming can be executed by the eDU PHY layer and/or by the Optical Signal Processing (OSP) Block. The two beam-forming technologies can be used separately or can be overlapped. A dedicated Optical Wavelength should be used for each Antenna Element or Antenna Port when using the OBF (Optical Beam-Forming) technology. After passing the OBF the radio signal is extracted by an Optical to Electric demodulator and is applied to the radio antenna array (TRP), which in turn forms beams in RF domain.

### Interference Management

In an embodiment of this invention, the inter-RRU interference can be identified as follows:
A. Identifying by a DU the non-served UEs in a given RRU proximity, as detailed below.
B. Scheduling the traffic to/from the given RRU in specific time-frequency resources, wherein a time interval may be a symbol, a slot, a subframe, a frame, while using the polarization and beams chosen by each served UE during the beam management procedure.
C. Muting or reducing the power and/or using a non-interfering polarity, and/or using non-interfering beams for the transmissions from/to the other RRUs in the same specific time-frequency resources, while using commands of the R-O System Controller to other DUs and/or to other RRUs.
D. Measuring the signals received from the given RRU by the non-served UEs in the given RRU proximity and reporting their power or energy, representing the given RRU interference to the non-served UEs, to the RAN-OPTO Controller.

### Digital Twin of the RRU-UE Pair

While within the existing RAN networks an RRU is permanently connected to a DU, in the converged R-O network an RRU may be connected through the OPTO network to different DUs during the time. Within the OPTO Network, a specific RRU installed at a specific location is assigned a specific RRU-ID identifier and this RRU-ID is transmitted to the current serving DU as part of a message sent by the R-O System Controller and/or by the activated RRU.

For building a real-time digital twin of the RRU-UE pair it is important to associate the UE measurement reports with the specific RRU which forwards these reports to the connected DU.

So, it is needed to verify the match between the PHY and antenna characteristics of the RRU and of the UE, for example common operating frequency bands, duplexing modes, etc.

In this invention the transmission of UE measurements from the MAC layer within the DU to the CU through the RRC protocol or to the R-O System Controller or to an Application is done through messages including the UE-ID and RRU-ID, specific to the RRU location within the OPTO network.

In this invention, in order to simulate the performance of the cellular network in a future location and at a future time moment it is needed to use a digital twin providing to the MAC layer the same relevant Channel State Information (CSI) measurement reports as the same UE operating at that future location and at that future time.

This means that the Digital Twin shall be based on measurements executed by similar UEs and it is necessary to create UE classes, each UE being categorized as belonging to a given class.

In actual operation, after receiving the CSI parameters, the gNB schedules downlink data transmissions configuring the modulation scheme, code rate, number of transmission layers, and MIMO precoding) accordingly.

In simulated operation, the gNB schedules the data transmission based on the relevant CSI parameters received from the UE-RRU Digital Twin.

As previously said, in order to assess the performance of different UEs in a future location, it is needed to assign a given UE to a UE class, based on the requirement that UEs within the same class will provide similar measurement reports when placed in the same 3D location and operating on same radio channels.

This task should be executed by an AI/ML (Artificial Intelligence/Machine Learning) algorithm, for each given location.

In addition, in both training and inference phases, all UEs shall be configured with identical CSI measurement resources and measurement report configurations through RRC messages.

As result, time-frequency resources dedicated to training phase or to inference phase must be defined within the PHY time-frequency resources.

The CSI Report for 5G technology includes the following relevant reports of significance for throughput calculations:
A. Channel quality indicator (CQI); currently, the 3GPP standard TS 38.214 provides four 4 bits CQI tables, covering modulations from QPSK to 1024 QAM and different code rates. One of the tables is dedicated to BLER (Block Error Rate) criteria of 0.00001 and the three others to BLER criteria of 0.1.
B. Rank indicator (RI), for multiple input multiple output (MIMO) scenarios. The RI defines the number of possible layers for the downlink transmission under specific channel conditions. The RI also corresponds to the maximum number of uncorrelated paths that the downlink transmission can use.

Both CQI and RI, as reported by UE, indicate the possible instantaneous performance. In an embodiment of this invention, in order to use them as Digital Twin of the UE CSI measurement reports, CQI and RI reports provided by UE are filtered, preferably before transmitting them to the network.

In an embodiment, recent reports from UEs in the same class and same location as the UE future location may get priority over the filtered CQI and RI reports.

In case of deteriorating QoS, current reports of measured RSRQ and/or CQI may be used for finding the cause of QoS deterioration.

Alternatively, for uplink, a current serving DU can measure the power of the Sounding Reference Signals transmitted on a specified UE antenna and received by a given RRU.

### RRU Identification

The RRU identification in the unified RAN-OPTO network can be integrated with the Beam Management Procedure, i.e. at specified moments of time and on a specified frequency resource and on a specified polarization (if different antenna polarizations are used) only one RRU transmits one of its beams.

In this invention the transmitting or receiving RRU is enabled by the R-O System Controller, which also transmits this information to the current connected DU, which will further transmit the UE measurement results to one or more of the higher layer entities comprising the CU and/or an application receiving measurement results related to the RRU.

The connected higher layer entities will collect for each activated RRU the reports from the UEs located in the proximity to the activated RRU and/or their pre-processing and their CSI reports and/or received power/energy for each antenna sector, layer or beam, measured on SSB or CSI-RS.

Alternatively, the RRU activation is executed by the serving DU to which the RRU is connected.

Creating the RAN-OPTO digital twin in multiple locations makes possible the digital twin creation for an entire AREA.

The obtained digital twin for an AREA can be used for user data scheduling prevision and assessing of the fulfillment of the QoS (Quality of Service) requirements on different possible routes on terrestrial or aerial routes.

In an embodiment of this invention, in case that the use of the CQI and RI Digital Twin indicate that the QOS requirements cannot be fulfilled, the R-O system controller will take actions for making available enough radio resources in advance, at the future location of the UE.

Evolved Distributed Unit (eDU) Block Diagram

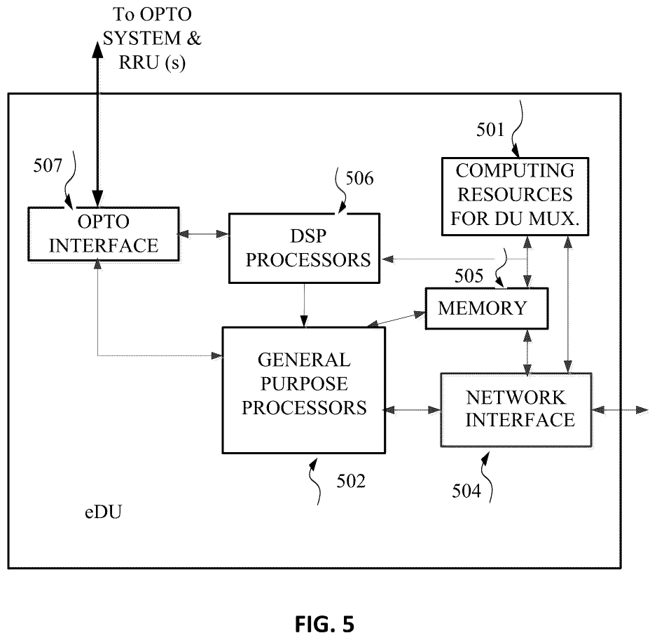

The eDU blocks shown in FIG. 5 are only by way of example; in practical implementations these blocks can be distributed on multiple circuit boards, and the control functions and hardware functions can be implemented on commercial processors or tailor-made logical arrays, such as system-on-a-chip, FPGAs, ASICs.

The eDU includes a Computing Resources for implementing a User Plane Multiplexer-501, Central Control Unit implemented on General Purpose Processors—502, DSP processors—506 connected to an OPTO interface—507. The network (communication) interface—504 enables message transmission to Core Network, to the AREA R-O Controller other RAN (Radio Access Network) units or to the OAM (Operations, Administration and Maintenance).

The Central Controller—502 includes a central or distributed MAC for assigning PHY resources to the connection of one or more UEs, while using a Uu or a Sidelink technology, to the component DUs within the eDU. A memory block—505, containing, for example, RAM and non-volatile memory (FLASH or ROM) is used by the Central Control Unit—502. The data used by the controller—502 may be stored in the memory block—505.

### Computing Platform

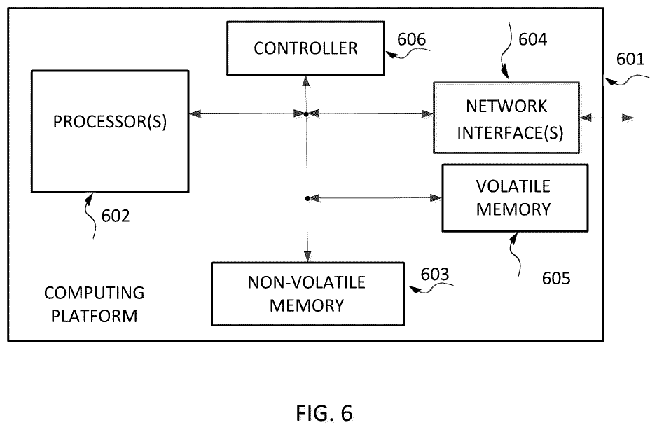

A computing platform 601 (see FIG. 6) is a system that consists of one or more specialized processors 602, non-volatile memory 603, volatile memory 605, network communication interfaces—604 and a system controller 606. An application, program or process runs over an operating system installed in the computing platform.

The computing resources of a computing platform can be dynamically allocated to one or more partitions, for example containers or virtual machines, such that each container or virtual machine can use a number of processor cycles and a partition of the volatile and non-volatile memory. If implemented, each virtual machine may run its own operating system, such that multiple operating systems can coexist on the same computing platform.

The computing platform includes time synchronization means (see FIG. 2A) that allow the synchronization of the entire RAN-OPTO System.

### Area R-O System Controller Implementation

The Area R-O System Controller includes software modules, adapted for controlling the RAN-OPTO system nodes based on the received information.

The Area R-O System Controller controls the RAN-OPTO system nodes/entities operation and receives operational status information from eDU entities, from OPTO system nodes and from UEs.

Artificial Intelligence models, like Large Quantitative Models (LQM), are suited for resolving numerical problems and are suitable for deriving conclusion on the real-time RAN-OPTO system configurations. They leverage advanced machine learning techniques, including statistical methods, optimization algorithms, and complex calculations.

The Area R-O System Controller includes hardware computing resources such as one or more processors, memory, communication interfaces.

The Central Coordinator may use dedicated enclosures or can run its software on a partition of computing resources belonging to a computing platform, as shown in FIG. 6.

### UE Block Diagram

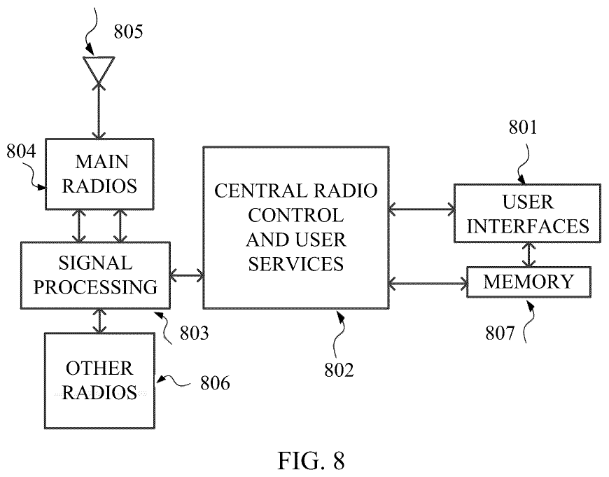

FIG. 8 shows the UE block diagram. The central radio control, including the functions related to the User Plane and Control Plane as described in 3GPP TS 36.300 and radio activities, is located within a central processing unit 802, which may also perform other high-layer user services, including running user applications. In such a case, the computing resources of the central processing unit 802 may be allocated to different containers or virtual machines, wherein each virtual machine can run its own operating system. In an embodiment, a dedicated processor is allocated for running user applications. The user application is in fact a computer software product, stored on a Server on the Internet and/or comprising a non-transitory computer-readable medium on which program instructions are stored. The user application is downloaded to a non-volatile memory belonging to the memory block 807 of the UE.

The user interfaces, such as the display, speaker, microphone, industrial interfaces, and industrial sensor interfaces are located in a user interface block 801.

A memory block 807, containing RAM and non-volatile memory (FLASH or ROM) is used by the central processing unit 802 and depending on the actual UE implementation, may be used also by the user interfaces 801.

Digital signal processing is performed by a signal processing block 803 and can give services to the radios using FDD or TDD for communication, like radios 804, for the cellular operation in licensed and un-licensed bands, and also to other radios—806, such as WiFi and Bluetooth, operating generally in license-exempt bands. Antennas 805 can be used for receive (RX) and transmit (TX), while using diplexers or switches to connect them. If the receive and transmit radio frequencies are far from each other, however, different antennas may be used.

### Technologies

The description of this invention uses terminology currently available for the 5G-NR technology. It shouldn't be considered that the invention is limited to this deployment mode, i.e. the sublayers included in a DU may be included in a virtualized base station or in a non-virtualized base station and the description is also pertinent to these deployment options.

As it will be appreciated by those skilled in the art, the terminology used throughout the specification is mainly that which is associated with LTE and 5G standards. However, it should be understood that embodiments of the present invention encompass other wireless technologies as IEEE 802.11 technology and its associated stations and future generations of cellular technologies.

The examples provided show certain ways of carrying out the invention. It is to be understood that invention is not intended to be limited to the examples disclosed herein. Rather, the invention extends to all functionally equivalent structures, methods and uses, as are within the scope of the claims.

List Of Abbreviations

| | |
|---|---|
| AI | Artificial Intelligence |
| AON | Agile Optical Network |
| ASIC | Application Specific Integrated Circuit |
| BLER | Block Error Rate |
| BS | Base Station |
| CQI | Channel Quality Indicator |
| CU | Central Unit |
| CS | Core System |
| CSI | Channel State Information |
| D2D | Device to Device |
| D/A | Digital to Analog |
| DL | Downlink |
| DSP | Digital Signal Processor |
| DU | Distributed Unit |
| DWDM | Dense DWM |
| E/O | Electrical to Optical |
| eCPRI | enhanced Common Public Radio Interface |
| eDU | enhanced DU |
| FDD | Frequency Division Duplex |
| FFT | Discrete Fourier Transform |
| FLASH | (non-volatile memory) |
| FWID | Optical Fiber and Wavelength Identifier |
| FPGA | Field Programmable Gate Array |
| GPS | Global Positioning System |
| HO | HandOver |
| I/O | Input/Output |
| ID | Identifier |
| IEEE | Institute of Electrical and Electronics Engineers |
| iFFT | inverse FFT |
| IP | Internet Protocol |
| ISO | International Organization for Standardization |
| ITU | International Telecommunication Union |
| MAC | Medium Access Control |
| MCS | Modulation and Coding Scheme |
| ML | Machine Learning |
| MIMO | Multiple-Input Multiple-Output |
| NR | New Radio (aka 5G) |
| OADM | Optical Add-Drop Multiplexer |
| OFB | Optical Fiber |
| OPTO | Optical |
| O-RAN | Open-RAN (Alliance) |
| OSP | Optical Signal Processor |
| PDCP | Packet Data Conversion Protocol |
| PDSCH | Physical Downlink Shared Channel |
| PER | Packet Error Rate |
| PHY | Physical, Physical Layer |
| PTP | Precision Time Protocol |
| QAM | Quadrature Amplitude Modulation |
| OBF | Optical Beamforming |
| QPSK | Quadrature Phase-Shift Keying |
| QoS | Quality of Service |
| R-O | Radio-Opto |
| RAM | Random Access Memory |
| REM | RE-Modulation |
| RAN | Radio Access Network |
| RF | Radio Frequency |
| ROM | Read Only Memory |
| RRU | Remote Radio Unit |
| RU | Radio Unit |
| TDD | Time Division Duplex |
| TRP | Transmit Receive Point |
| TTD | True Time Delay |
| UL | Uplink |
| UP | User Plane |
| WDM | Wavelength Division Multiplexing |
| WSS | Wavelength Selective Switch |

1. A method for providing cellular radio services, comprising:
partitioning a base station in a Radio Access Network (RAN) into a Central Unit (CU) including at least a PDCP (Packet Data Conversion Protocol), one or more evolved Distributed Units (eDU), serving User Equipments (UE) within a given deployment area and including at least two Distributed Units (DU), each DU including at least a MAC (Medium Access Control) functional entity and a part of the PHY (Physical) Layer, and at least one Remote Radio Unit (RRU), associated with the eDU and including at least a Radio Frequency (RF) amplifier, connected through an Optical (OPTO) Network to the eDU and through radio to at least one User Equipment (UE) located within the at least one RRU coverage area;
establishing a controller of the unified RAN-OPTO system operation within the given deployment area;
selecting, by the RAN-OPTO system controller, at least one DU for conveying user data and control information between one or more specific RRUs and the at least one selected DU;
establishing, by the RAN-OPTO system controller, a communication path between the CU and the at least one selected DU;
establishing, by the RAN-OPTO system controller, an optical communication path through the OPTO configurable nodes, between the at least one selected DU and the one or more specific RRUs;
performing by the at least one UE, through the RAN and OPTO networks, the procedures for connection to the cellular network; and
conveying user data and/or control information between the CU and the at least one UE through the at least one selected DU and the one or more specific RRU.

2. The method according to claim 1, wherein selecting by the RAN-OPTO system controller of at least one DU involves configuring a multiplexer/demultiplexer of UP (User Plane) data, included within the eDU, for conveying user data between the CU and the at least one selected DU.

3. The method according to claim 1, wherein the multiplexer/demultiplexer of UP data redirects the UE traffic, under the control of the RAN-OPTO system controller, from the current serving DU to the target serving DU, the redirection being intended for UE mobility support, DU load balancing and UE dual connectivity.

4. The method according to claim 1, wherein the RAN-OPTO system controller is connected through one or more dedicated E/O and/or O/E converters and one or more wavelengths to controllable entities of the OPTO Network.

5. The method according to claim 4, wherein the controllable entities of the OPTO Network are at least one from the list of: tunable lasers, WDM add/drop multiplexer, Optical Switch, OSP (Optical Signal Processing) block, True Time Delay (TTD) unit, splitters, blockers, O/E converters and RRUs.

6. The method according to claim 1, wherein Area R-O System Controller allocates a specific wavelength per each data stream to/from a certain layer or antenna port of the at least one DU.

7. The method according to claim 1, wherein the eDU provides connectivity to the served UEs through an optical fronthaul, using at least one optical wavelength chosen by the RAN-OPTO system controller, up to specific O/E converters associated with the one or more RRUs connected to Radio Antennas.

8. The method according to claim 1, wherein the optical fronthaul conveys messages according to eCPRI (enhanced Common Public Radio Interface) protocol.

9. The method according to claim 1, wherein the PHY layer of the DU executes pre-coding and each pre-coded layer is transmitted while using a different wavelength.

10. The method according to claim 1, wherein the handover process involves only the Optical network which redirects, based on messages from the RAN-OPTO system controller, the UE traffic from a serving RRU to another RRU.

11. A method according to claim 5, wherein at least a part of the controllable functions of the OPTO network are executed by an Optical Signal Processing (OSP) Block.

12. The method according to claim 5, wherein controllable nodes provide reports to the RAN-OPTO system controller on their status and/or information on message routing towards the final target.

13. The method according to claim 5, wherein controllable nodes are configured or re-configured by the RAN-OPTO system controller through appropriate messages.

14. An OSP Block according to claim 11, executing FFT (Fast Fourier Transform) and/or iFFT (inverse FFT) functions.

15. Apparatus for deployment in a Radio Access Network (RAN), in which a base station is partitioned into a Central Unit (CU) including at least a PDCP (Packet Data Conversion Protocol), one or more evolved Distributed Units (eDU), serving User Equipments (UE) within a given deployment area and including at least two Distributed Units (DU), each DU including at least a MAC (Medium Access Control) functional entity and a part of the PHY (Physical) Layer, and at least one Remote Radio Unit (RRU), associated with the eDU and including at least a Radio Frequency (RF) amplifier, is connected through an Optical (OPTO) Network to the eDU and through radio to at least one User Equipment (UE) located within the at least one RRU coverage area, the apparatus comprising:
a network interface;
a memory; and
at least one processor, which is configured to serve as RAN-OPTO controller of the unified RAN-OPTO system operation within the given deployment area and the RAN-OPTO system controller selects at least one DU for conveying user data and control information between one or more specific RRUs and the at least one selected DU, and the RAN-OPTO system controller establishes a communication path between the CU and the at least one selected DU, and the RAN-OPTO system controller establishes an optical communication path through the OPTO configurable nodes, between the at least one selected DU and the one or more specific RRUs, and the at least one UE performs the procedures for connection to the cellular network and the unified RAN-OPTO system conveys user data and/or control information between the CU and the at least one UE through the at least one selected DU and the one or more specific RRU.

16. The apparatus from claim 14 wherein the RAN-OPTO system controller is connected through one or more dedicated E/O and/or O/E converters and one or more wavelengths to controllable entities of the OPTO Network.

17. The apparatus from claim 15 wherein the controllable entities of the OPTO Network are at least one from the list: tunable lasers, WDM add/drop multiplexer, Optical Switch, OSP (Optical Signal Processing) block, True Time Delay (TTD) unit, splitters and blockers, O/E converters and RRUs.

18. The apparatus from claim 14, wherein for a Wavelength Selective Switch (WSS) the configurations refer to routing, blocking and attenuating of specific DWDM wavelengths within WSS.

19. The apparatus from claim 14 wherein the its processor configures the operation of an OSP (Optical Signal Processing) Block.

20. A system providing cellular radio services, comprising a base station in a Radio Access Network (RAN) partitioned into a Central Unit (CU) including at least a PDCP (Packet Data Conversion Protocol), one or more evolved Distributed Units (eDU), serving User Equipments (UE) within a given deployment area and including at least two Distributed Units (DU), each DU including at least a MAC (Medium Access Control) functional entity and a part of the PHY (Physical) Layer, and at least one Remote Radio Unit (RRU), associated with the eDU and including at least a Radio Frequency (RF) amplifier, is connected through an Optical (OPTO) Network to the eDU and through radio to at least one User Equipment (UE) located within the at least one RRU coverage area, a controller of the unified RAN-OPTO system operation within the given deployment area which selects at least one DU for conveying user data and control information between one or more specific RRUs and the at least one selected DU, and establishes a communication path between the CU and the at least one selected DU and an optical communication path through the OPTO configurable nodes, between the at least one selected DU and the one or more specific RRUs, the system supporting the at least one UE for performing, through the RAN and OPTO networks, the procedures for connection to the cellular network and for conveying user data and/or control information between the CU and the at least one UE through the at least one selected DU and the one or more specific RRU.
